(19) United States
(12) Patent Application Publication
(10) Pub. No.: US 2015/0148720 A1
(43) Pub. Date: May 28, 2015

(54) Discreet Sexual Stimulation Apparatus

(71) Applicants: Robert Harmon, Cedar Grove, NJ (US); Dawn Adams Harmon, Cedar Grove, NJ (US)

(72) Inventors: Robert Harmon, Cedar Grove, NJ (US); Dawn Adams Harmon, Cedar Grove, NJ (US)

(21) Appl. No.: 14/325,628

(22) Filed: Jul. 8, 2014

Related U.S. Application Data
(60) Provisional application No. 61/870,953, filed on Aug. 28, 2013.

(51) Int. Cl. A61H 19/00; A63H 13/00; A63H 3/00; A61H 23/02

(52) U.S. Cl. CPC A61H 19/30; A61H 23/02; A63H 13/005; A63H 3/003
USPC 601/70

(57) ABSTRACT

A device for discretely providing sexual stimulation, the device being in the form of a plush animal having a head portion, a body portion, at least one appendage wherein the head portion includes a face region formed at least in part from an impermeable flexible material, the face region having a hollow interior defining an inner surface including at least one internally mounted vibrator motor provided with a rotatably drivable eccentric mass is securely affixed therein, said vibrator motor positioned in close proximity opposite an outer surface of the face region for transferring vibrations to a region of said face defining a vibration area, said vibrator motor being operatively connected to a power source and a control circuit and wherein said vibration area provides an operative portion for applying vibratory sensations to a part of the human body.

### CROSS-REFERENCE TO RELATED APPLICATIONS

The present patent application is based on Provisional Application Ser. No. 61/870,953, filed Aug. 28, 2013, the entirety of which is hereby incorporated by reference.

This invention relates generally to a sexual stimulation apparatus and particularly to a discreet sexual stimulation apparatus designed to be incorporated in typical bedroom décor and display which is for use primarily by women to increase their personal comfort when using the sexual stimulation apparatus during masturbation or with a partner. More specifically, the present invention relates to such an apparatus in the form of a plush or stuffed animal, such as a teddy bear, in which at least one vibrator mechanism for stimulating the genital regions of a user is housed therein. The vibratory mechanism is disposed within a semi-rigid flexible portion of the stuffed animal, such as the face, mouth, tongue and/or nose, so that the vibratory oscillations are most effectively transmitted when placed at or near the erogenous zones and/or genital regions of a user.

### BACKGROUND OF THE INVENTION

Various known devices for stimulating the female genitalia have been developed for the purpose of providing sexual gratification and climax. Generally, they are used for personal pleasure and recreation by providing the user healthy sexual outlets. They are sometimes also used in combination with sex-therapy programs. The sexual devices can provide the user an opportunity for sexual exploration and development, alleviate fears and anxiety about sexual performance, aid in the development of one's sensual capacities, and even facilitate verbal, emotional and sexual communication between sex partners. The most common form of such device is the vibrator, which operates by applying pressure, friction, and vibration to the clitoral region, walls of the vagina and/or external areas of the genitalia.

Vibrator-type sex aids are devices made to vary or enhance pleasure during sexual activity. Vibrators can be used on the body and skin to stimulate the nerves for a relaxing and pleasurable feeling. Some vibrators are designed to ergonomically stimulate erogenous zones for erotic stimulation and are used primarily on the genitals or around the genitals; however they can also be used on other parts of the body as well. People frequently use sex aids when they are on their own as well as with partners as part of sexual activity. Typically, people who use sex aids do not use them every single time they engage in sex nor do they always use the same aid on each occasion. Ideally, sex aids are simply a facet of or a means to increase healthy sexual expression and enjoyment.

Sexual stimulation apparatus are well known and come in a variety of shapes and sizes. They have been commercially available for many decades. For example, the American company Hamilton Beach patented the first electric vibrator available for personal use as opposed to medical usage, making the vibrator the fifth domestic appliance to be electrified, after the sewing machine, fan, tea kettle, and toaster, and about a decade before the vacuum cleaner and electric iron. The home versions soon became extremely popular, with advertisements in periodicals such as Needlecraft, Woman's Home Companion, Modern Priscilla, and the Sears, Roebuck catalog; however, these disappeared in the 1920s, apparently because their appearance in pornography made it no longer tenable for mainstream society to avoid the sexual connotations of the devices.

In the 1960's the modern “personal” vibrator re-emerged as a by-product of the sexual revolution. In 1966, an application was made for a patent for the “Cordless Electric Vibrator for Use on the Human Body”. That application referenced an earlier patent issued in 1940, for a flashlight with phallic shape which left little doubt as to a possible alternate use. The cordless vibrator was patented on Mar. 28, 1968, and was soon followed by such improvements as multi-speed and one-piece construction, which made it cheaper to manufacture and easier to clean.

Conventional sexual stimulation masturbation apparatuses and devices include dildos, vibrators and the like and are typically made from plastic, metal, silicone, rubber or other similar materials. Many of these devices have a straight or curved shaft that is typically shaped to resemble a phallus. The shaft typically does not include a handle and at best, the shaft may include a bulbous end to assist in a user gripping the sexual stimulation apparatus during use.

However, because the shaft of a conventional sexual stimulation apparatus does not often include a handle, it is difficult for a user to grip a conventional sexual stimulation apparatus comfortably during use. This can be particularly problematic for women when using these types of devices because of the anatomical position of a woman's vagina in relation to their arms and hands. Thus, a user, and particularly a female user, may experience tension, fatigue, discomfort or pain in their wrist, upper arm, and shoulder and/or back when using a conventional sexual stimulation apparatus when masturbating.

Without a handle, a conventional sexual stimulation device may be difficult to hold comfortably by a user, and particularly a female user, with their wrist in a natural and comfortable orientation. It is difficult for a female user of a conventional sexual stimulation apparatus to insert the conventional sexual stimulation apparatus comfortably into their own vagina during masturbation and keep their wrist in a natural and comfortable orientation.

US 2002/0188233 (Denyes) describes a vibrating stimulation device, which an individual user cannot easily or comfortably use when masturbating. The shape and configuration of the Denyes vibrating stimulation device requires that a second operator uses the device on their partner. The “gun-shaped” handle of the Denyes device does not provide an individual user with any ergonomic benefits and does not allow an individual user to utilize the “palms down” technique when in use, which allows a single user to access her vagina while the user is in a comfortable and ergonomically beneficial orientation.

U.S. Pat. No. 5,853,362 (Jacobs) describes an intravaginal glandular stimulation device, which an individual user cannot easily use during masturbation with a “palms down” technique. While the intravaginal glandular stimulation device of Jacobs does include a handle the handle is used merely to “grasp” the device and the handle does not ergonomically contour with the individual user's hand nor does the handle sit snugly against the palm and fingers of the user's hand.

The intravaginal glandular stimulation device of Jacobs is specifically designed for G-Spot induced orgasm and thus clitoral stimulation is not a priority of the Jacobs device. Many women have reported that they find it easier to achieve orgasm when both the vagina and the clitoris are stimulated. The Jacobs device also does not have a definitive end portion and is therefore not intended to be fully inserted into an individual user's vagina or anus. In this way, the Jacobs device is most effective when used by two people simultaneously. The Jacobs device is adapted to simultaneously stimulate two users at once and accordingly has two insertable ends.

For some women, the use of phallic shaped vibrators can be controversial and/or is avoided for political, cultural or personal reasons. In response, a variety of non-phallic shaped vibrators, which do not in any way resemble the penis, have been developed. Typically, these non-phallic devices are in the form of eggs, wands, ellipses, curvilinear shapes and/or U-shaped configurations but in order to employ them as intended, there is typically some type of penetrative aspect to their use. And while many women frequently enjoy penetration for sexual excitation, in medical literature masturbatory preferences for orgasm are reportedly overwhelmingly clitoral. Thus, in many instances penetration is neither typically required nor desired.

The use of sexual devices of other penetrative and non-penetrative designs and configurations is known in the art. More specifically, sexual devices of known designs and configurations previously devised and utilized for the purpose of providing therapeutic relief and/or sexual stimulation through known methods and apparatuses are known to consist basically of familiar, expected, and obvious structural configurations, notwithstanding the myriad of designs encompassed by the crowded prior art which has been developed for the fulfillment of countless objectives and requirements.

By way of example, U.S. Pat. No. 4,722,327 to William J. Harvey discloses a therapeutic apparatus. U.S. Pat. No. 4,790,296 to Segal discloses a sexual stimulation apparatus. U.S. Pat. No. 4,846,158 to Teranishi discloses a hand type electric massage machine. U.S. Pat. No. 5,076,261 to Black discloses a motor-driven therapeutic apparatus. U.S. Pat. No. 5,460,597 to Hopper discloses a portable hand-held vibratory feminine stimulator. Lastly, U.S. Pat. No. 5,725,473 to Taylor discloses yet another sexual aid.

Moreover, there are many non-patented sexual stimulation apparatuses. The Sybian is one such device designed for females that the woman sits atop and can be penetrated by a mechanically actuated dildo. Two motors provide differing action; one vibration and a second a peculiar form of rotation. The dildo doesn't actually revolve within the user but the top sweeps through a circular arc while the base remains stationary. The inventors (Abco Research Associates) self-report on their website manufacturing and selling ‘hundreds’ of Sybians at $1400 since 1987. There are also Sybian-like machines that are available commercially from diysybian.com that are based on the original Sybian. While less costly than the Sybian, these DIY (do-it-yourself) devices still remain relatively expensive in the $300 to $500 range.

As will be appreciated from a review of the known art, many of the known devices are cumbersome, noisy, and expensive, can require special stands or bases in order to use them. Additionally these devices are usually stored, locked away or out-of-sight, in order to avoid the possible and unfortunately, typical embarrassment that can be associated with their use and enjoyment.

Finally, as is shown by two published patent applications US 20080032594 A1 and US 20080032595 A1 there has been an attempt at providing a plush animal in the form of Teddy Bear having an internal pocket or secret compartment with an external orifice where a vibrator/massager device may be hidden and retrieved for personal enjoyment.

While these devices fulfill some of their respective, particular objectives and requirements, the aforementioned patents and prior art do not provide discreet sexual stimulation apparatus designed to be incorporated in typical bedroom décor and display for use by women to increase their personal comfort when using the sexual stimulation apparatus during masturbation or with a partner that allows providing therapeutic relief and stimulation to a female user. Additionally, even where there is some modicum of suitability as part of typical bedroom décor as in the case of the above published patent applications, a user must still retrieve the vibrator/massager device from the internal pocket or secret compartment with an external orifice by partially or completely disrobing the stuffed animal, which may undoubtedly interfere with or impede the spontaneity of its use. Moreover, these devices are not at all suitable for use outside of the privacy of a user's bedroom, such as in a television or family room or in a car while traveling as a passenger.

In this respect, the sexual aid system according to the present invention substantially departs from the conventional concepts and designs of the prior art, and in doing so provide an apparatus primarily developed for the purpose of providing therapeutic relief and stimulation to a female user without the need to remove or conceal devices and without having to partially or completely disrobe the stuffed animal in order to retrieve the vibrator/massager device from the internal pocket or secret compartment with an external orifice. Therefore, it is an object of the present invention to provide an improved sexual stimulation apparatus which goes at least some way towards overcoming or minimizing the prior art problems or limitations outlined above or at least providing a viable alternative thereto.

Therefore, it can be appreciated that there exists a continuing need for a new and improved discreet sexual aid system which can be used for providing therapeutic relief and stimulation to a female user. In this regard, the present invention substantially fulfills this need. There is also a need for unusual and decorative carriers or housings for useful articles such as sexual aid devices; and in particular there is need for the decorative device of the present invention, wherein the vibratory means is permanently housed within a region of a stuffed animal and which is capable of transmitting vibratory sensations. As will appear, the article may comprise a familiar and non-threatening plush animal such as a teddy bear or some other plush animal form or doll. In such a form, there is no need for inconspicuous concealment of or even the use of the vibrator. There is also no need for the cumbersome steps of having to retrieve a hidden vibrator/massager by first disrobing the stuffed animal. Thus, the present invention allows the user easy and immediate access to sexual aid device within a person's private domain where its use is typically employed as well as being suitable for use in other rooms or other locations where it may be enjoyed inconspicuously.

### SUMMARY OF THE INVENTION

The present invention pertains to a discreet sexual aid device to create stimulation by massage of one or more erogenous zones of the human body. More specifically, the invention is a plush or stuffed animal, such as a teddy bear, that has at least one vibrator motor installed within a cavity of the face and/or muzzle of the teddy bear that would not otherwise appear to be a sex aid device or sex toy. The face and/or muzzle of the plush animal may be formed of pliable, flexible semi-rigid plastic materials that non-reactive to human skin and bodily fluids and permit transmission of the vibrations to the nose and tongue portions of the face without substantial damping of the vibrations. The vibrating device is securely fitted into the face and/or muzzle of the stuffed animal's face (forming a vibration area) and may be activated via controls preferably located in the extremities of the animal, such as the arms, legs, ears or other body parts.

In an embodiment, the face and/or muzzle is fabricated so as to be moisture proof and easily cleaned. In other embodiments, the face and/or muzzle has a simulated tongue member that is formed as a lateral extension of the face and/or muzzle in a shape and dimension preferably facilitating contact with the clitoris of a user of the device. In still other embodiments, a first vibrator motor may be supported within the head member or within a cavity of the face and/or muzzle member and a second vibrator motor may also be supported within the face and/or muzzle cavity proximate the internal distal end of the tongue member. The advantage of such an arrangement is that each vibrator motor may be controlled separately providing the desired level of stimulation to specific portions of the genital region. Each of the vibrators typically includes a two-piece housing enclosing a vibrator motor that rotates an eccentric weight member in a conventional manner and as further described below.

### DETAILED DESCRIPTION OF THE DRAWINGS

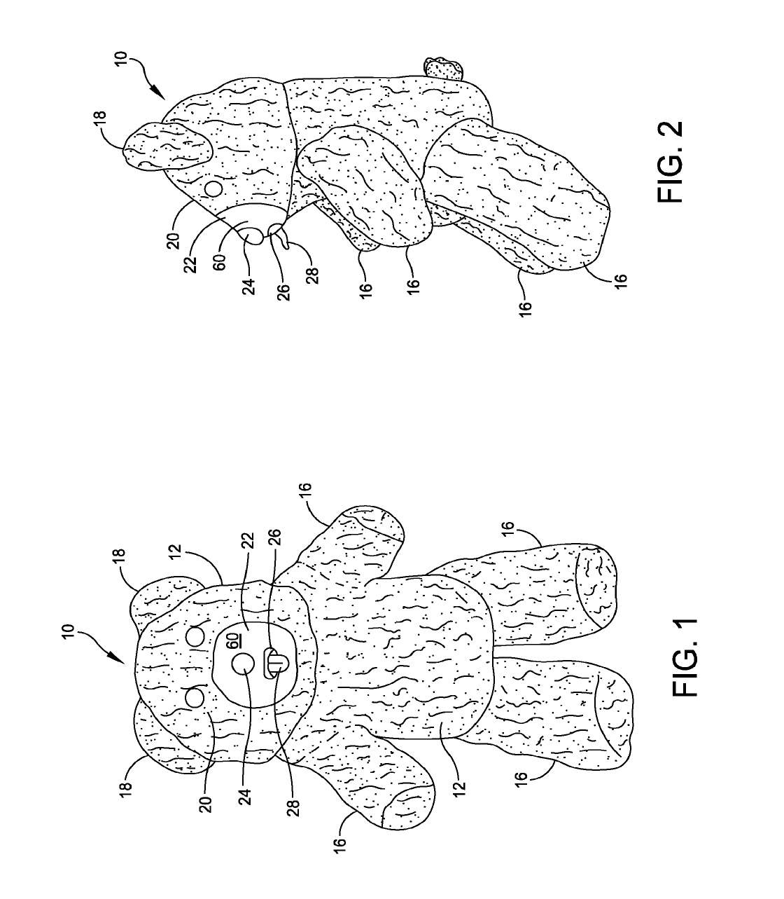

FIG. 1 is a front elevational view of a discreet sexual aid stuffed animal, such as teddy bear;

FIG. 2 is a left side view of the discreet sexual aid stuffed animal of FIG. 1;

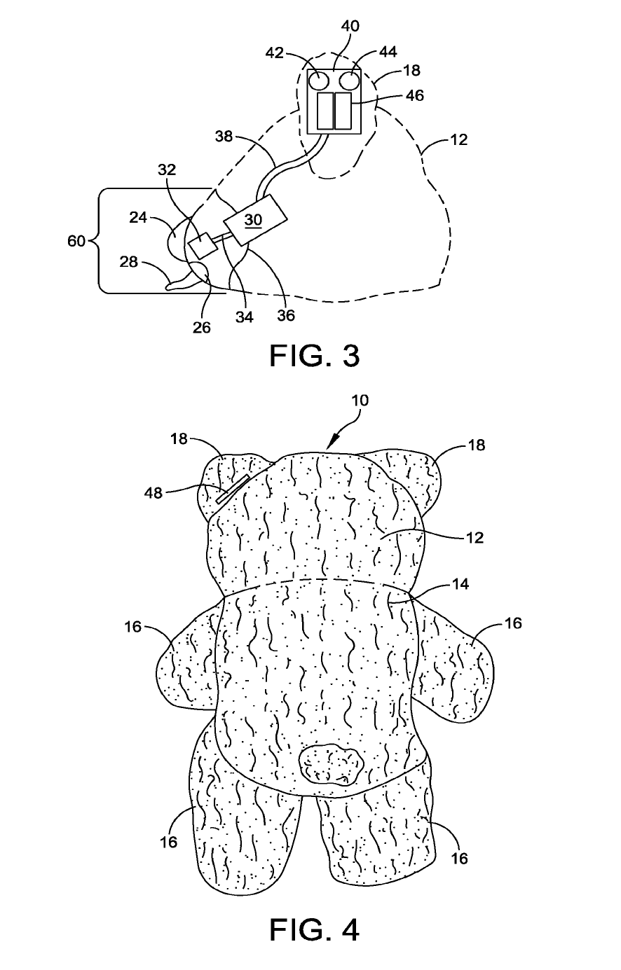

FIG. 3, is a phantom cross sectional view of the head portion of the discreet sexual aid stuffed animal of FIG. 2;

FIG. 4 is a rear elevational view of the discreet sexual aid stuffed animal of FIG. 1;

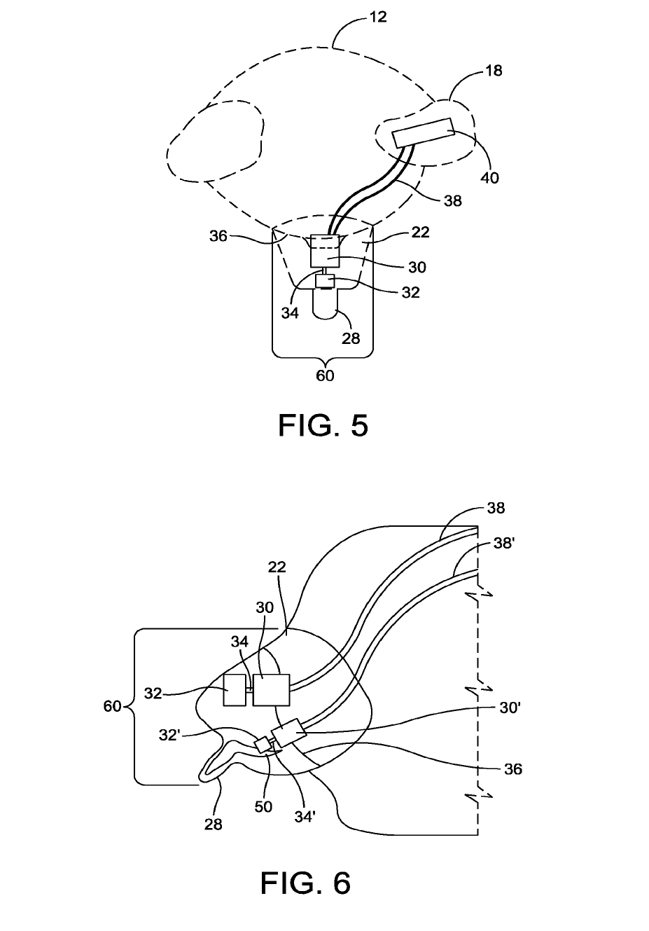

FIG. 5 is a phantom cross sectional top view of the head member of discreet sexual aid stuffed animal of FIG. 4;

FIG. 6 is a partial, phantom side cross sectional view of a head, face portion and muzzle member of an alternative form of a discreet sexual aid useful in the present invention.

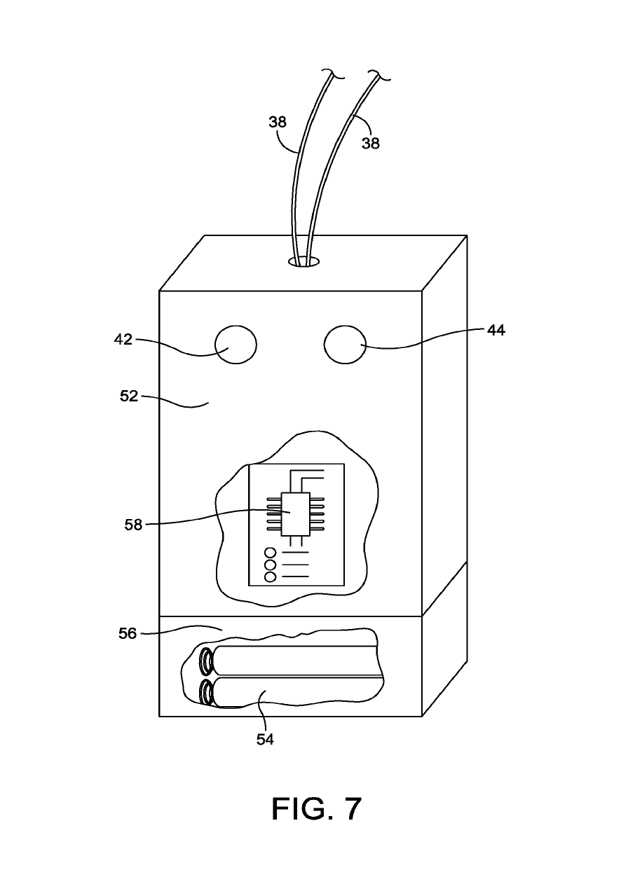

FIG. 7 is a partially exploded front perspective view of an embodiment of a control module useful in the present invention.

### DETAILED DESCRIPTION OF THE INVENTION

The following description of preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

As used herein, the term stuffed animal or plush animal is not limited to the teddy bear shown in the embodiments and the drawings. Suitable forms of the stuffed animals contemplated by the present invention can include, by way of example, domestic animals such as dogs and cats, as well as, monkeys, lions and tigers and other animals that may be suitable to include in domestic decor. Additionally, since one of the advantages of the present invention is to facilitate an increased comfort level with masturbatory activity as well as ease of access to the device, it will be appreciated that any form of stuffed or plush animal having a head portion with a nose member and mouth region would be included within the scope of the invention. Furthermore, as used herein, the term “muzzle member” refers generally to the naso-oral region and is not limited to the protruding part of an animal's face consisting of its nose, mouth, and jaw. In many animals the equivalent structure is called a rostrum or a proboscis. Additionally, as used herein, appendages shall be construed to include arms, legs, ears and any other outward extension of a stuffed animal head or torso.

FIGS. 1 and 2 show one form of the invention, a stuffed animal 10 having the form of a decorative teddy bear, having a head member 12, body member 14 and appendage members 16. FIG. 1 is a front elevational view and FIG. 2 is a side elevational view. Positioned at the top of head member 12 are ear members 18. Head member 12 further includes a generally centrally located face region 20, including a muzzle member 22. Positioned at the end of muzzle member 22 is nose member 24 which is positioned above mouth region 26 that may optionally include tongue member 28 collectively forming vibration area 60. Muzzle member 22 of stuffed animal 10 is preferably formed of pliable, flexible semi-rigid plastic materials that permit transmission of the vibrations to nose member 24 and tongue member 26 of face region 20 without substantial damping of the vibratory sensation created by the internal mechanisms detailed below. Suitable lightweight plastic materials include rigid and flexible vinyls, polypropylenes, polystyrenes, norell, polysulfones, ABS, polyethylenes, polycarbonates and other bio-compatible materials such as silicone which are non-reactive to human skin and bodily fluids.

In FIG. 3 there is shown a phantom cross-sectional view of the head portion of the discreet sexual aid stuffed animal of FIG. 2. Like reference numerals refer to structural items previously identified. Within head 12, there is positioned in the face region 20, at or near the muzzle member 22 vibrator motor 30. Vibrator motor 30 includes an eccentrically weight 30 positioned on shaft 34 of vibrator motor 30. Vibrator motor 30 is securely positioned within motor mount 36, which is adapted to receive and permanently hold vibrator motor 30 in place by conventional means including compressive fitment, sonic welding, epoxy glues, hot melt glues and other suitable adhesive materials. Extending from vibrator motor 30 to control module 40 is a pair of wires 38 which deliver electrical current from a power source (not shown) to vibrator motor 30. Vibrator motor 30 may further include a two-piece housing enclosing vibrator motor 30 having a shaft 34 for rotating eccentric weight member 32 in a conventional manner and as further described below. Eccentric weight member 32 can take the form of a cam or other elliptical shape capable of inducing vibrations as a result of the axis of rotation being weighted out of balance. Preferably, the vibration provided is operable at variable speeds, frequencies and/or pulses. Preferred vibration rates can be adjusted from approximately 20 per second to approximately 200 per second or higher.

The device of the present invention comprises at least one vibration area 60 for placing in contact with the erogenous zones and/or genital regions of a user, or each vibration area 60 being acted upon by at least one vibration arrangement which comprises vibration motor 30 which, in use, drives eccentric weight 32 to create vibration at a frequency determined by the speed of the vibrator motor 30 during use.

The vibration is transmitted to, and then to the body of a subject against which the vibration area 60 is held. The vibration motor 30 is preferably a low-voltage DC electric motor. The speed of each motor is controllable in a manner conventional in itself, such as by variation of a control signal, supply voltage or the like. Vibration motor 30 is controlled from the control module 40, which also provides power from power source 46. Control module 40 includes control circuit 58, which may be a microprocessor, microcontroller or the like. Control circuit 58 is operable to control the supply of power from the power source 46 to vibration motor 30 and is further able to control the speed of vibration motor 30. In other embodiments shown below, control circuit 58 is able to control a plurality of vibrator motors 30 and 30′ separately, so that the speed, frequency and pulsing of each vibration motor is set independently of the speed, frequency and pulsing of the other vibration motor.

In the embodiment shown in FIGS. 3 and 7, control module 40, is positioned within ear member 18. Control module 40 further includes power actuator switch 42, intensity switch 44 and power source 46. Control module 40 includes a control housing 52 which also encloses power source 46 comprising battery module 54 (which is retained by a removable cover 56) and circuit board 58, there being appropriate wiring or other conductors (not shown) between the battery module 54, control circuit 58, and vibration motor 30. Suitable materials for control module 40, control housing 52, and switches 42 and 44 include ABS. Suitable materials for battery module 54 and removable cover 56 include polypropylene; a suitable battery complement is two to four type AAA alkaline batteries. In an embodiment, power source 46 battery module 54 may consist of conventional long lasting batteries with suitable voltage to power vibrator motor 30. In alternate embodiments, battery module 54 may comprise rechargeable NiCad, NIMH and/or lithium-ion batteries which can be recharged in situ via a house current step down transformer charger of the type typically used for cellular telephones, telephone answering machines, and other similar rechargeable electronic devices.

In the configuration shown in FIGS. 1-5, and FIG. 7 control module 40 has a power switch actuator 42, and an intensity switch 44 each actuator protruding from the housing 50 for operation by a user and having an associated switch (not shown) on control circuit 58. Control circuit 58 may optionally include additional operational adjustment switches for facilitating operation and enjoyment by the user. A mode switch for example, may sequentially select a plurality of varying vibration and pulsing combinations, by selectively activating vibrator motor 30 in accordance with methods known to those skilled in the art. A speed switch actuator may further sequentially select different speeds of both vibration speed intensity and pulsing, also in accordance with methods known to those skilled in the art.

Additionally, control module 40 may optionally include additional switches and/or functions to vary pulsing and/or timing of the vibrations which may provide additional sensory stimulation and variation. It will be further appreciated that these functions may be combined in a single switch or on-off switch 42 and intensity switch 44 may include additional functions for the purpose of providing additional sensory stimulation and variation.

FIG. 4 shows the rear elevational view of the discreet sexual aid of the present invention. Positioned at or near ear 18 is access flap 48, which provides internal access to control module 40 for the purposes of changing batteries and/or recharging power source 46. Access flap 48 may be fold of material or a closure including a hook and loop fabric or snap fits. It will be appreciated that control module 40 may also be positioned within appendages 16 and that a plurality of control modules may be employed in alternate embodiments. For example, on-off switch 42 may be positioned within the ear 18, while intensity switch 44 and/or pulsing and timing switches (not shown) may be positioned in one or more of appendages 16. Further still, it will be understood that access flap 48 would preferably be positioned at or near power source 46 to permit ease of access for changing or recharging batteries.

FIG. 5 is a phantom cross sectional top view of head member 12 of the discreet sexual aid stuffed animal of FIG. 4. As shown in the drawing, control module 40 is positioned within ear 18 and is connected to vibrator motor 30 via wires 38. Vibrator motor 30 is securely fitted into motor mount 36 which may be integrally formed within the interior surface of muzzle member 22. Preferably, motor mount 36 may also include epoxy glue, hot melt glue or other similar adhesive materials to ensure that vibrator motor 30 remains securely in place. Positioned on shaft 34 of vibrator motor 30 is eccentric weight 32 in operational contact with muzzle member 22, nose member 24 and tongue member 28. In this regard, when vibrator motor 30 is activated, the elliptically mounted weight transfers the vibrational sensations throughout the muzzle, nose, and tongue members, 22, 24 and 28 respectively. By varying the speed and intensity of the vibrations, the user can apply the desired vibration areas 60 and 60′ to the desired region or regions of the genitalia. Preferably, in an embodiment, the simulated tongue member 28 that is formed as a lateral extension of muzzle member 22 is of a shape and dimension which facilitates contact with the clitoris of a user of the device. Preferably still, eccentric weight 32 is in operative contact with a tang or extension of tongue member 28 which extends inwardly into the body of muzzle member 22.

In FIG. 6 there is shown a phantom side cross-sectional view of a portion of the head, face and muzzle member of an alternative form of the present invention. In this embodiment it will be appreciated that muzzle member 22 includes a pair of vibrator motors, 30 and 30′. Vibrator motors 30 and 30′ receive electrical power via wires 38 and 38′ from power module 40 (not shown). Include eccentric weights 32 and 32′ mounted on shafts 34 and 34′ respectively. Motors 30 and 30′ need not be identical in terms of power output or rpms; similarly, eccentric weights 32 and 32′ mounted on shafts 34 and 34′ may be of different mass and weight to provide additional sensory variety. Motors 30 and 30′ are securely mounted within motor mounts 36 and 36′ positioned on the interior surface of muzzle member 22. From the drawings it will be seen that vibrator motor 30 is positioned at or near that portion of muzzle member 22 corresponding most closely to nose member 24. Vibrator motor 30′, it will be seen, is positioned close to or on tongue extension member 50, which extends from tongue member 28 into the interior of muzzle member 22 so as to provide separate and distinct stimulatory vibration from that provided by vibrator motor 30.

It will be understood that in the embodiments shown in FIG. 6, as well as other embodiments not shown, where a plurality of vibrator motors is used, it may be preferable to include separate control modules 40 and 40′ and/or separate switches including but not limited to on-off switch 42 and intensity switch 44 or other optional operational switches for controlling pulsing or intensity of the vibrations.

In other embodiments, a plurality of vibrator motors 30 are provided operable at variable frequencies to provide variable vibration frequency arrangements. The frequency of each variable frequency vibration arrangement is preferably settable substantially independently of the frequency of each other variable frequency vibration arrangement. Preferably still, at least one vibration area is acted upon by a plurality of vibration arrangements, to produce variable frequencies and sensations within a given vibration area. Alternatively, each vibration area may be acted upon by a respective vibration arrangement, the vibration areas being sufficiently proximate to produce complimentary frequencies on a common contact region of a user.

Preferably control modules 40 and 40′ are operative for changing vibration speeds of a first motor and the vibration mechanism in response to a singular operator-controlled element. Preferably, one or more control modules 40 are operable to set the frequency of each variable frequency vibration arrangement. The control module 40 may be operable to control the frequency of each variable frequency vibration arrangement to vary during use. The control means may be operable to vary the frequencies to create a predetermined pattern of complimentary frequencies. Alternatively, control modules 40 can include separate operator-controlled elements for independent speed control of the first vibrator motor 30 and of a second vibration motor 30′. The positioning of the control modules 40 and/or separate and additional switches is a matter of design choice to facilitate the user the most convenient ease of operation and enjoyment of the device of the present invention.

While the foregoing description and drawings represent the exemplary embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What I claim as my invention is:

1. A device for sexual stimulation comprising:
a plush animal having a head portion, a body portion, at least one appendage;
said head portion comprising an outer surface of impermeable flexible material which covers at least partially a face region of said animal,
said face region having a hollow interior defining an inner surface, wherein said inner surface includes at least one mount for at least one vibrator motor provided with a rotatably drivable eccentric mass is securely affixed therein, said vibrator motor positioned in close proximity opposite the outer surface of said face region for transferring vibrations to a region of said face defining a vibration area,
said vibrator being operatively connected to a power source and a control circuit and further wherein said vibration area provides an operative portion for applying vibratory sensations to a part of the human body.

2. The device of claim 1 wherein the impermeable flexible material is selected from the group comprising lightweight plastic materials including rigid and flexible vinyls, polypropylenes, polystyrenes, norell, polysulfones, ABS, polyethylenes, polycarbonates and bio-compatible materials such as silicones which are non-reactive to human skin and bodily fluids.

3. The device of claim 1 wherein said vibration area comprises a nose member.

4. The device of claim 1 wherein said vibration area comprises a muzzle member.

5. The device of claim 1 wherein said vibration area comprises a tongue member.

6. The device of claim 1 wherein said vibration area comprises at least one member selected from the group consisting of nose, muzzle and tongue members.

7. The device of claim 1 wherein said inner surface includes at least two mounts for at least two vibrator motors provided with rotatably drivable eccentric masses are securely affixed therein.

8. The device of claim 7 wherein said vibrator motors are substantially identical in power and rpms.

9. The device of claim 7 wherein said rotatably drivable eccentric masses are weighted differently.

10. A sexual stimulation device comprising a plush animal having a vibrator unit disposed therein,
the vibrator unit comprising a first housing within said plush animal in which is disposed an electric motor provided with a rotatably driveable eccentric mass whereby operation of the electric motor produces vibrations,
at least one battery being disposed in a second housing for providing power to the electric motor,
a control module for connecting said battery to said electric motor and further including at least one switch for controlling said electric motor,
wherein said plush animal further comprises an operative portion for applying vibratory sensations to a part of the human body.

11. The device of claim 10 wherein the first housing is selected from the group comprising impermeable flexible lightweight plastic materials including rigid and flexible vinyls, polypropylenes, polystyrenes, norell, polysulfones, ABS, polyethylenes, polycarbonates and bio-compatible materials such as silicones which are non-reactive to human skin and bodily fluids.

12. The device of claim 10 wherein said operative portion comprises a nose member.

13. The device of claim 10 wherein said operative portion comprises a muzzle member.

14. The device of claim 10 wherein said operative portion comprises a tongue member.

15. The device of claim 10 wherein said operative portion comprises at least one member selected from the group consisting of nose, muzzle and tongue members.

16. The device of claim 10 wherein said inner surface includes at least two mounts for at least two vibrator motors provided with rotatably drivable eccentric masses are securely affixed therein.

17. The device of claim 17 wherein said vibrator motors are substantially identical in power and rpms.

18. The device of claim 17 wherein said rotatably drivable eccentric masses are weighted differently.

19. The device of claim 10 wherein the battery is rechargeable.

20. The device of claim 16 wherein the at least two vibrator motors are selectively operable via said control module.
